(19) United States
(12) Patent Application Publication
(10) Pub. No.: US 2013/0179240 A1
(43) Pub. Date: Jul. 11, 2013

(54) METHOD AND SYSTEM FOR SPONSORED ON-LINE FUNDRAISING

(71) Applicants: Nicholas J.W. Lee, North York (CA); Steve Croth, Toronto (CA); Mark Bachman, Whitby (CA)

(72) Inventors: Nicholas J.W. Lee, North York (CA); Steve Croth, Toronto (CA); Mark Bachman, Whitby (CA)

(21) Appl. No.: 13/346,005

(22) Filed: Jan. 9, 2012

(51) Int. Cl. G06Q 30/02

(52) U.S. Cl. 705/14.1

(57) ABSTRACT

A method and system for sponsored online fundraising in relation to an offer for purchase provided by a retailer, the fundraising campaign, the fundraising service and the retailer having respective account balances. The method comprises matching retailer offers against the fundraising campaign specifying a plurality of campaign criteria; generating a plurality of offers for purchase from among the retailer offers; selecting at least one offer for purchase from among the generated offers for purchase; publishing a fundraising campaign promoting the at least one offer; selecting and purchasing the offer promoted by the fundraising campaign; generating a voucher specifying the monetary value of the purchased offer; redeeming the voucher via a purchase transaction with the retailer, and allocating, from at least a portion of the monetary value, a first payment to the fundraising campaign account balance and a second payment to the fundraising service account balance.

### FIELD

The present disclosure relates generally to a method and system for sponsored online fundraising amongst fundraising promoters, business sponsors and a supporting buyer community.

### BACKGROUND

Fundraising activities are typically performed by a fundraiser targeting and soliciting potential supporters. In some cases, a retailer may take on a role of fundraiser, desiring an enhanced profile within a local community, a larger regional community or even nationally, as a supporter of certain fundraising causes deemed meritorious. In general, the process of targeting and successfully identifying potential donors or supporters remains inefficient, especially in view of the fact that taking on such a fundraising role is outside of the typical business retailer's area of expertise and core business proficiency. Indeed, to the extent that taking on such a role is distracting from the core business of the retailer, the retailer may not fully realize a positive, business-enhancing image within the community.

### SUMMARY OF THE INVENTION

Provided is a computer-implemented method, executed in a processor of a fundraising platform server associated with a fundraising service, of funding a fundraising campaign in relation to an offer for purchase provided by a retailer, the fundraising campaign, the fundraising service and the retailer having respective account balances, the fundraising campaign and the offer being accessible to a fund supporter computing device. The method comprises matching, at the fundraising platform server, a plurality of retailer offers against the fundraising campaign, the fundraising campaign specifying a plurality of campaign criteria; generating, based on the matching, a plurality of offers for purchase from among the plurality of retailer offers; selecting, via a fundraiser computing device, at least one offer for purchase from among the generated plurality of offers for purchase, the at least one offer comprising a monetary value; publishing, via the fundraiser computing device, a fundraising campaign promoting the at least one offer; selecting and purchasing, via a supporter computing device, the at least one offer promoted by the fundraising campaign; generating a voucher at the fundraising platform server, the voucher specifying the monetary value of the purchased at least one offer; redeeming the voucher via a purchase transaction with the retailer, the purchase transaction comprising at least a portion of the monetary value; and allocating, from the at least a portion of the monetary value, a first payment to the fundraising campaign account balance and a second payment to the fundraising service account balance.

Also provided is a fundraising system for funding a fundraising campaign in relation to an offer for purchase provided by a retailer, the fundraising campaign and the offer being accessible to a fund supporter computing device. The system comprises a matching module at a fundraising platform server associated with a fundraising service, the matching module for matching a plurality of retailer offers against the fundraising campaign, the fundraising campaign specifying a plurality of campaign criteria, the matching module generating a plurality of offers for purchase from among the plurality of retailer offers and further generating a voucher, the voucher specifying the monetary value of a purchased at least one offer selected from among the plurality of retail offers; a fundraiser computing device for selecting the at least one offer for purchase from among the plurality of retail offers, the at least one offer comprising a monetary value, the fundraiser computing device further for publishing the fundraising campaign promoting the at least one offer; a supporter computing device for purchasing the at least one offer promoted by the fundraising campaign; and an accounts module for tracking redemption of the voucher via a purchase transaction with the retailer, the purchase transaction comprising at least a portion of the specified monetary value of the voucher, the accounts module further for allocating, from the at least a portion of the monetary value, a first payment to a fundraising campaign account balance of the fundraising campaign and a second payment to a fundraising service account balance of the fundraising service.

### BRIEF DESCRIPTION OF THE DRAWINGS

Embodiments will now be described by way of example only, with reference to the following drawings in which:

FIG. 1 shows an embodiment architecture for a computer based fundraising system;

FIG. 2 is a flowchart illustrating an embodiment of a process for retail sponsors of fundraising programs;

FIG. 3 is flowchart illustrating an embodiment of a process for promoters of a fundraising campaign;

FIG. 4 is a flowchart illustrating, in one embodiment, a method of funding a fundraising campaign in relation to an offer for purchase provided by a retailer;

FIG. 5 illustrates an embodiment of a web page, hosted at the fundraising platform server of FIG. 1, as accessed by the fundraiser computing device showing selection of retailer offers during creation of a fundraising campaign; and

FIG. 6 illustrates, in one embodiment, a web page hosted at the fundraising platform server of FIG. 1, displaying exemplary metrics related to a retail sponsor and a fundraiser.

### DETAILED DESCRIPTION

Accordingly, there is a need for providing more efficient means and systems involved in fundraising activities, in which retail-level supporters, fundraising campaigner promoters and retail business sponsors would be encouraged and motivated to participate.

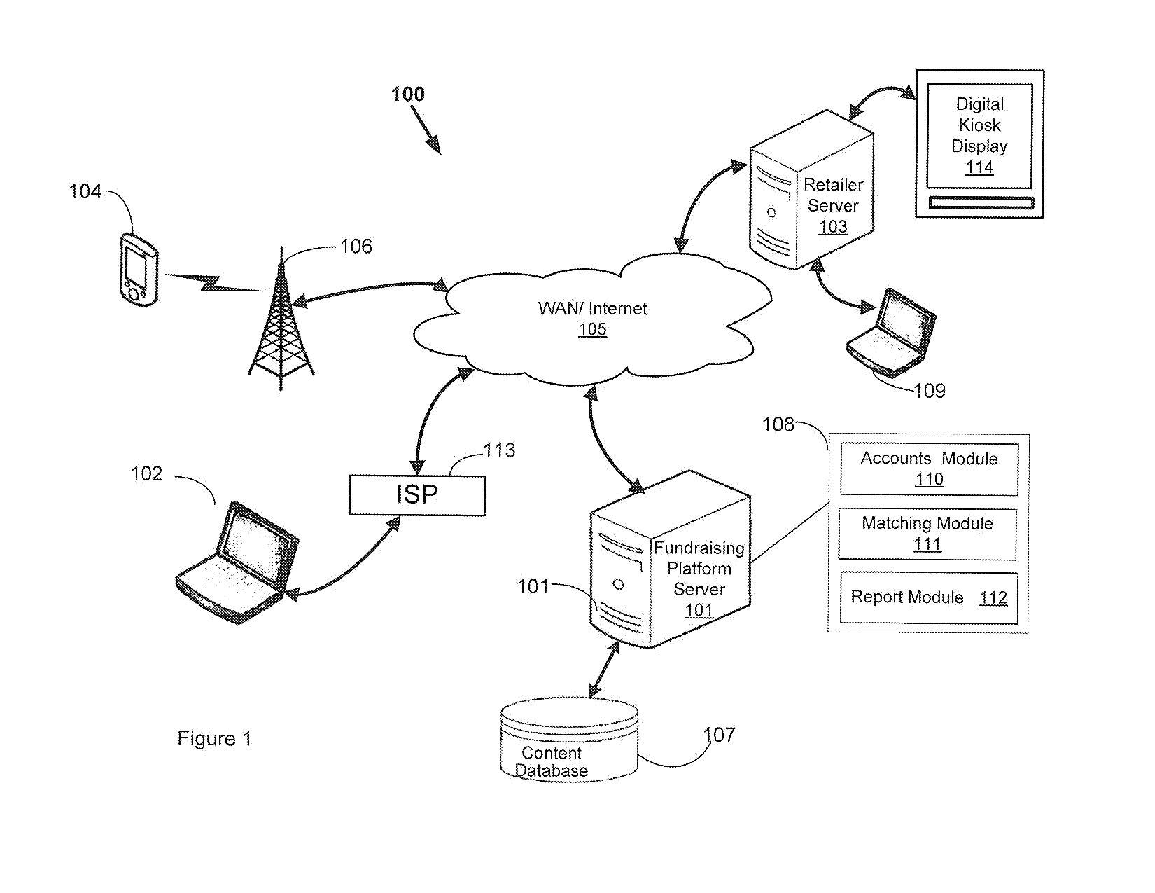

FIG. 1 shows an embodiment architecture for a computer based fundraising system 100.

Fundraising system 100 is directed to funding a fundraising campaign based on an offer for purchase provided by a business or enterprise sponsor (also referred to as a retailer herein), such as a business that targets retail-level customers. Retail-level customers, who prospectively fund and support fundraising programs, may access fundraising system 100 via fund supporter computing device 104. A fundraising campaigner or promoter, typically members of the public or other community, may access fundraising system 100 via fundraiser computing device 102. Retail businesses who may wish to sponsor or be associated with desired fundraising programs may access fundraising system 100 via retailer server device 103. Fund supporter computing device 104, fundraiser computing device 102 and retailer server device 103 are communicatively linked, via a wide area network 105 such as the Internet, to fundraising platform server 101 hosting fundraising service 108.

Notwithstanding the specific device-type depictions provided for illustrative purposes only in FIG. 1, fund supporter computing device 104 and fundraiser computing device 102 may be a client computing device, including a laptop computer, a tablet computer, a wireless handheld computing device such as a mobile phone or Personal Digital Assistant (PDA), or a desktop computer, and able to connect to wide area network 105 over cellular networks via a wireless service provider/carrier system infrastructure 106, or via internet service provider 113. Retailer server 103 is provided with a suitable computing interface terminal 109, which may be a laptop computer, a tablet computer, a wireless handheld computer, or a desktop computer for interacting with, and accessing, fundraising platform server 101 via wide area network 105. Web-enabled digital kiosk display 114, which may also be a digital billboard, may be used to graphically and/or publicly display fundraising metrics associated with the retailer.

As will be appreciated by those skilled in the art, each of fund supporter computing device 104, fundraiser computing device 102 and also the computing interface terminal of retail server 101 may include a microprocessor which controls general operation of the respective device. The microprocessor may access and interact with additional computing device subsystems such as a display screen, flash memory, a random access memory, a keyboard, a speaker, a microphone, a short-range communications subsystem such as BLUETOOTH (Bluetooth™) for example, and any other computing device subsystems or peripheral devices.

With regard to each of fund supporter computing device 104, fundraiser computing device 102 and the computing interface terminal of retail server 101, operating system software used by their respective microprocessor may be stored in a persistent non-transitory memory store such as flash memory, which may alternatively be a read-only memory (ROM) or similar storage element for storing computer program instructions thereon. The microprocessor, in addition to its operating system functions, may enable execution of software applications on the respective computing devices. A predetermined set of applications may be installed on the client device 101 during its manufacture. These may typically include data (email, messaging) and voice communication applications, for example. The screen display of the computing devices may be used to visually present an application's graphical user interface (GUI) to the user. The user may manipulate application data by modifying information on the GUI using an input device such as a keyboard or other types of input devices, for example, a scroll wheel, trackball, light pen or touch sensitive screen.

It is further envisioned that fund supporter computing device 104, fundraiser computing device 102 and the computing interface terminal of retailer server device 103 may have installed thereon appropriate communication and web browsing functionality, thereby enabling creation, accessing and browsing of web pages of a web site, including web sites hosted at fundraising platform server 101, in one embodiment. Furthermore client-side fundraising software applications may be installed and operational on any of fund supporter computing device 104, fundraiser computing device 102 and the computing interface terminal of retailer server device 103 to access and interact with the fundraising services provided by fundraising platform server 101.

Fundraising platform server 101 may include computing functionality and structure as described above for computing devices 102, 104, and provides and hosts central management functionality for fundraising system 100. Fundraising platform server 101 includes a processor able to execute computer program instructions for carrying out all of the functions of the various functional modules employed within fundraising platform server 101, such as fundraising platform service 108 which in turn comprises accounts module 110, matching module 111 and reports module 112. In one embodiment, any peer-to-peer communication or interaction amongst fund supporter computing device 104, fundraiser computing device 102 and retail server 103 are routed and managed through fundraising platform server 101. In yet another embodiment, such communication and interaction may be accomplished via web pages of a website hosted at fundraising platform server 101. The fundraising services provided via fundraising platform service 108 of fundraising platform server 101 may be made available and administered based upon an account creation and registration process offered to respective users at fund supporter computing device 104, fundraiser computing device 102 and retail server 103. Fundraiser platform server 101 may be communicatively coupled to content database 107, storing thereon and accessing therefrom records and metrics associated with the overall transactions performed within fundraising system 100.

Still with reference to FIG. 1, accounts module 110 of fundraising platform server 101 may comprise any combination of software and hardware. During a registration and account creation process, a fundraiser at fundraiser computing device 102 and a retailer at retailer server 103 may register to participate in fundraising system 100, and create an account. The account created includes details of the registrant, such as name, email address, and other identifying information, and also includes a monetary account balance, whereby monetary payment allocations arising from related fundraising transactions may be recorded and updated. Accounts module 110 further provides for tracking redemption of vouchers purchased by fund supporters (also referred to as buyers herein), for buying services or goods from sponsoring retailers, via a purchase transaction with a retailer. The purchase transaction may comprise the full voucher monetary amount, or at least a portion of the specified monetary value of the voucher. Subsequent to such purchase and redemption transactions by fund supporters, accounts module 110 may allocate a payment comprising a first portion of the voucher monetary value to a fundraising campaign account balance associated with the fundraiser's fundraising campaign, and also a payment comprising a second portion of the voucher monetary value to a fundraising service account balance of the fundraising service.

Matching Module 111 of fundraising platform server 101 may comprise any combination of software or hardware to perform the function of matching a plurality of retailer-sponsored offers for goods or services against a plurality of campaign criteria specified by the fundraiser of the fundraising campaign. The campaign criteria specified by the fundraiser of the fundraising campaign may include geographical factors, such as geographical region of a country/county or locality, and demographical factors such as age, gender, household income, and other factors associated with the prospective beneficiaries or beneficiary organization of the fundraising campaign, such as type of cause, type of medical condition or affliction, type of athletic sport involved, et cetera. The specified campaign criteria are applied by matching module 111 to determine which retail sponsors, and/or which of the retail sponsors' offers, qualify or become eligible for a given fundraising campaign as created by the fundraiser. In one embodiment, the fundraising amount may be matched to the inventory of retailer's offers required to meet a given fundraising goal or target. Matching module 111 generates a matched result of retailer offers for purchase by prospective fund supporters/buyer based on appropriately matched campaign criteria.

At this point, accounts module 110 further may trigger generation of a voucher, the voucher specifying the monetary value of a retailer offer (selected from among the matched results of retailer offers) that is actually purchased by a buyer/fund supporter.

Reports module 112 of fundraising platform server 101 may comprise any combination of software or hardware to perform the function of tracking, recording and publishing metrics related to fundraising transactions amongst fund supporter computing device 104, fundraiser computing device 102, retailer server device 103 and fundraising platform server 101. In one embodiment, reports module 112 compiles a fundraising report reflecting cumulative fundraising payments associated with the retailer.

Reports module 112 may publish, to a website associated with the retailer, the fundraising report reflecting cumulative fundraising payments associated with the retailer, in a show of sponsorship impact. Yet further, in one embodiment, the published information maybe displayed at web-enabled digital display screen 114, which may be a digital billboard or kiosk, at a location of the retailer.

Reports module 112 may also, or alternatively, publish the cumulative fundraising payments of the retailer to a website hosted by the fundraising platform server 101. Reports module 112 may also periodically update the cumulative fundraising payments associated with the retailer, and further may compile and publish a personalized fundraising campaign report reflecting cumulative fundraising payments associated with a given fundraiser's fundraising campaign, to show overall fundraiser impact.

The fundraiser at fundraiser computing device 102 selects one or more one offers, from among the matched results of retailer-sponsored offers generated from fundraising platform server 101, for promotion to prospective fund supporters/buyers at fund supporter computing device 104, who may then purchase the offer, such as by using online payment means, and then receive, electronically or otherwise, a voucher consistent with that monetary amount. Fundraiser computing device 102 is further used to launch the fundraising campaign, such as, but not limited to, use of social networking media, emailings, text messaging and email blasts to promote the offer and the associated fundraising cause being supported. In one embodiment, the fundraising campaign and the retailer offers for purchase may be provided at a website hosted by fundraising platform server 101.

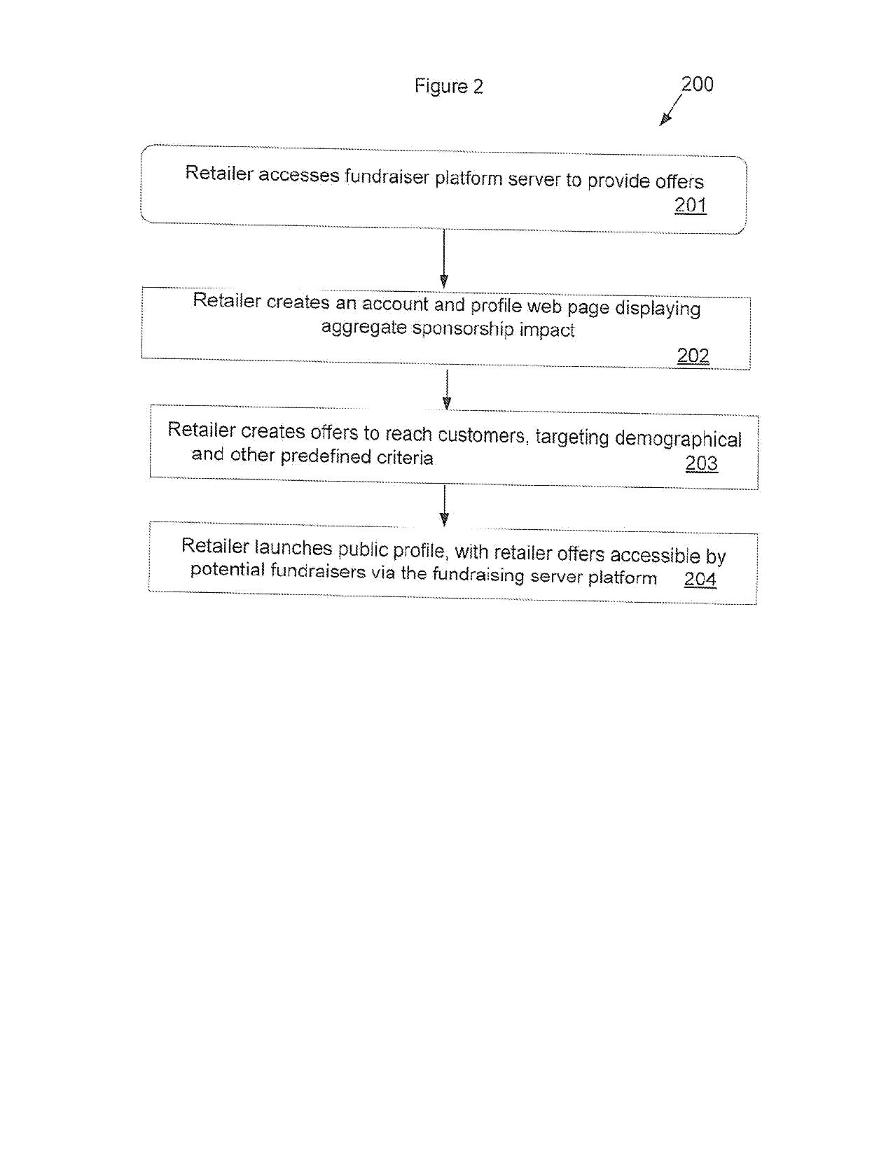

Now with reference to FIG. 2, illustrated is an embodiment of a retailer process 200 for retail sponsors seeking to sponsor fundraising causes or efforts. At step 201, the retailer via retailer server 103 accesses fundraiser platform server 101

At step 202, the retailer creates an account and profile web page displaying aggregate sponsorship impact.

At step 203, the retailer creates offers to reach prospective fund supporters/buying customers, targeting demographical, geographical, and other predefined criteria

At step 204, the retailer launches a retailer public profile web page, with retailer offers displayed to, and accessible by, potential fundraisers via the fundraising platform server 101.

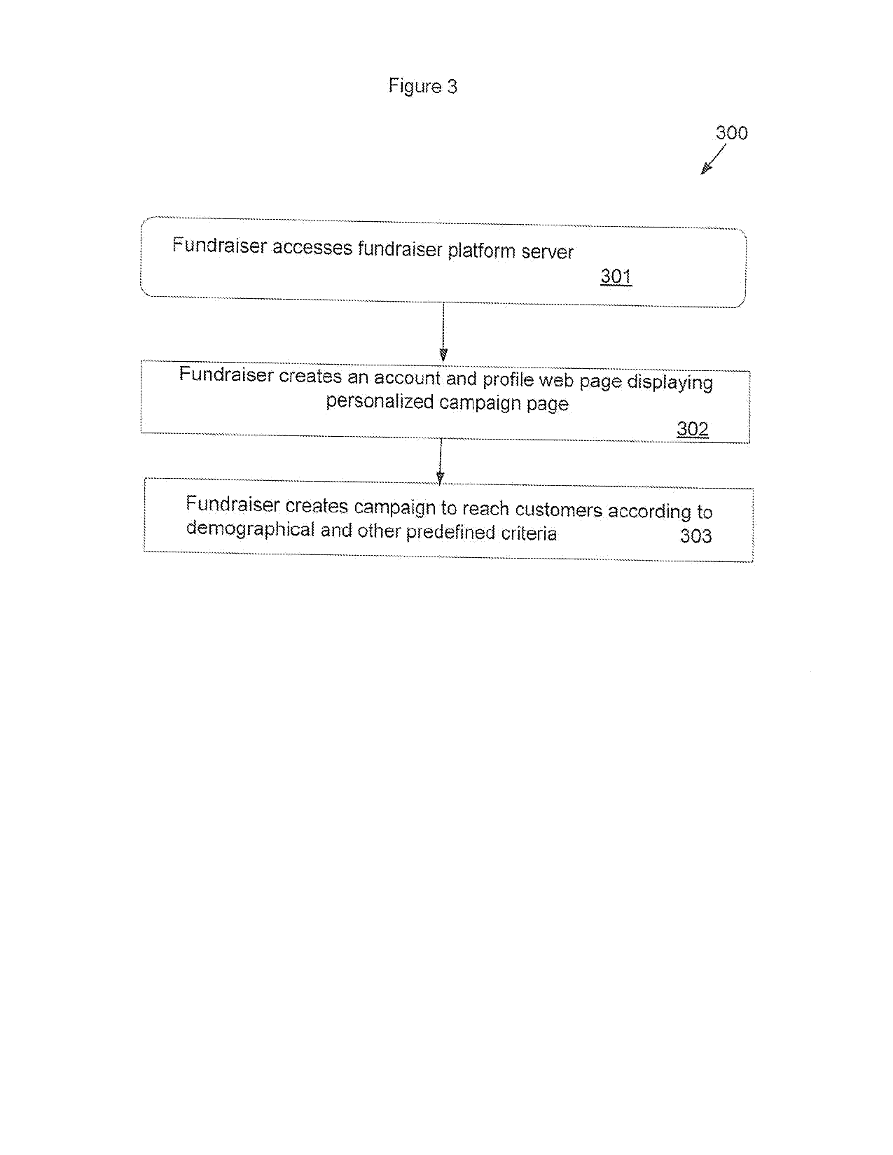

FIG. 3 illustrates an embodiment of a process 300 for fundraiser promoters of a fundraising campaign. At step 301, a fundraiser or fundraising promoter, accesses fundraiser platform server.

At step 302, the fundraiser registers, and creates an account and profile web page displaying personalized campaign page.

At step 303, the fundraiser creates a campaign to reach customers, specifying campaign criteria according to demographical, geographical and other predefined criteria.

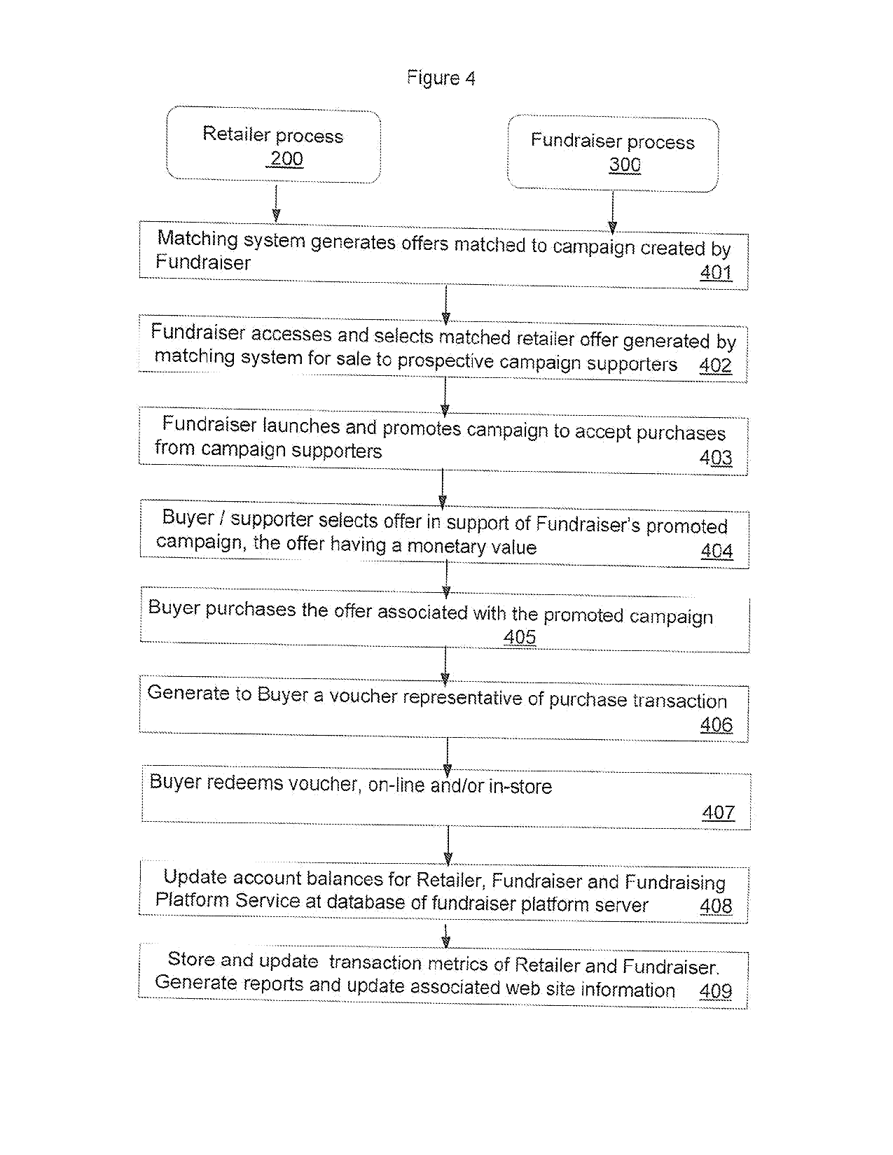

With reference now to FIG. 4, illustrated, in one embodiment, is a method of funding a fundraising campaign in relation to an offer for purchase provided by a retail sponsor. With retailer process 200 and fundraiser process 300 completed, at step 401, the matching system of matching module 111 generates sponsored retailer offers matched to the fundraising campaign created by the fundraiser, based on commonality criteria such as geographical and demographical factors.

At step 402, the fundraiser accesses and selects all retailer offers, generated as matching the fundraising criteria, for sale to prospective campaign supporters/buyers.

At step 403, the fundraiser publishes and promotes campaign, via use of social networking media, emailings, text messaging and email blasts, to prospective fund supporters.

At step 404, a fund supporter/buyer selects a promoted offer in support of Fundraiser's campaign, the offer specifying a monetary value.

At step 405, the buyer purchases the offer associated with the promoted campaign, such as using online payment methods.

At step 406, the fundraising platform server generates to the buyer a voucher representative of monetary amount of the purchase transaction.

At step 407, the buyer redeems voucher by purchasing goods or services from the retailer, via an on-line purchase or physically in a store.

At step 408, the account balances for retailer, fundraiser and fundraising platform service are updated at a database of fundraiser platform server 101, based on a predefined allocation thereto of portions of the monetary value of the voucher redemption amount.

At step 409, transaction metrics of retailer and fundraiser are stored and updated as transactions progress. Reports may be generated showing the cumulative results and efforts of the fundraising campaign as pertains to the fundraiser and the sponsoring retailer, for instance to show overall sponsorship impact.

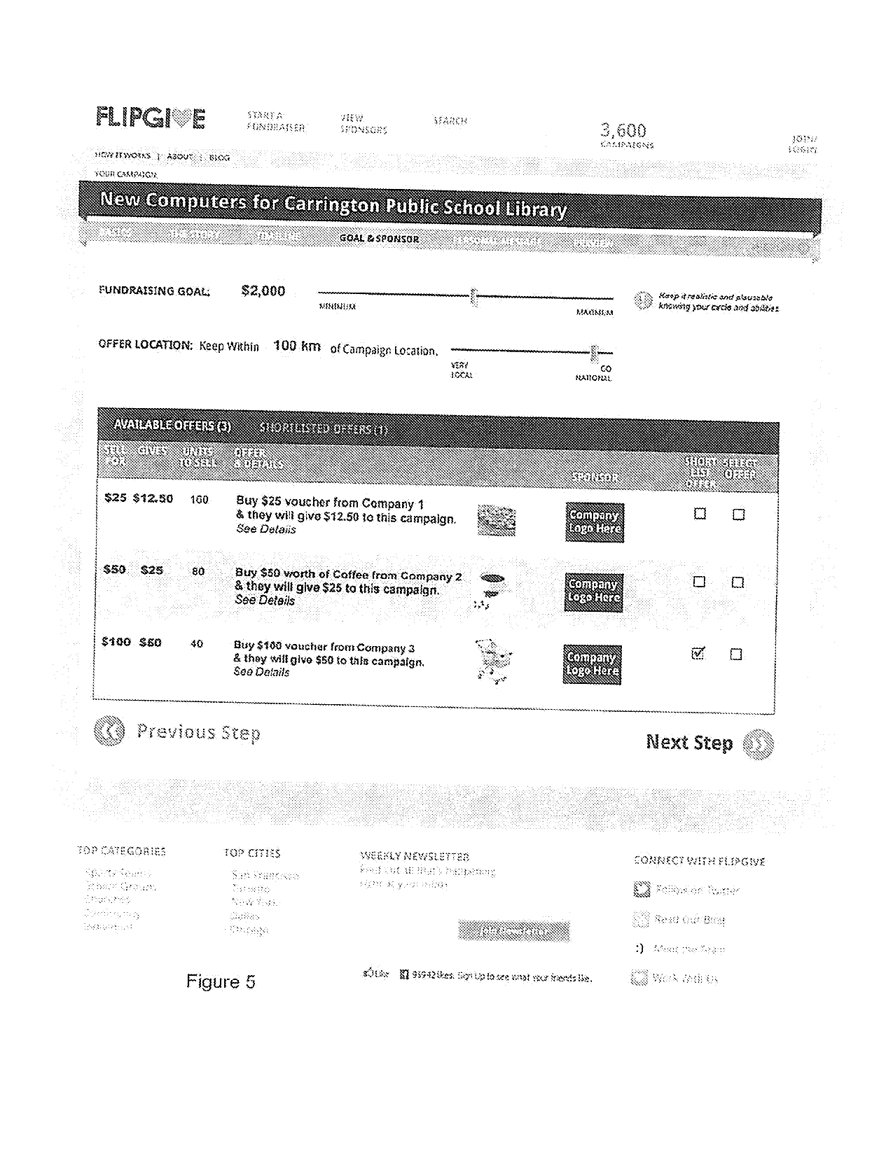

FIG. 5 illustrates, in one embodiment, a web page hosted at the fundraising platform server 101, as accessed by the fundraiser computing device 102 during selection of a retailer offer from among a result set (from the matching operations discussed previously) of retailer offers during creation of a fundraising campaign.

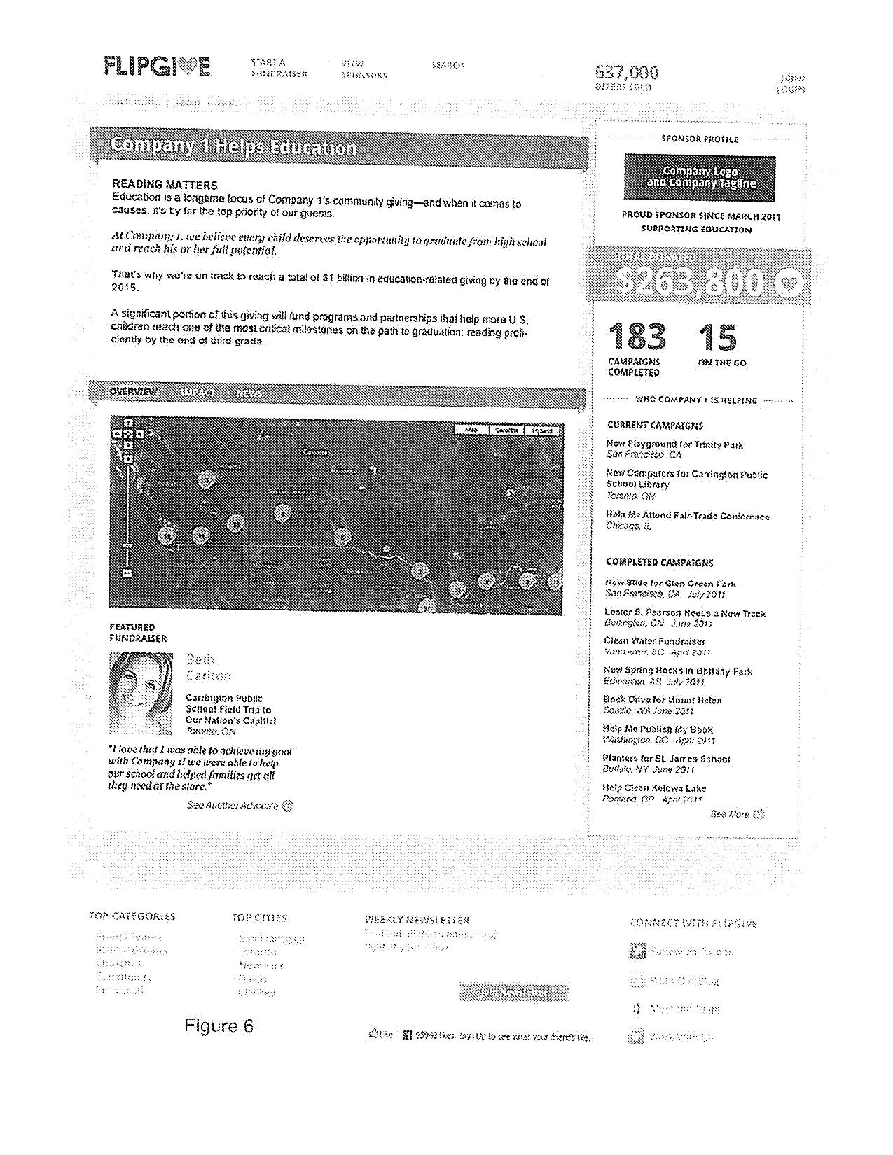

FIG. 6 illustrates, in one embodiment, a web page hosted at the fundraising platform server 101, displaying exemplary metrics related to a retail sponsor and a fundraiser. It is envisioned that the metrics are based on cumulative results relating to any or all aspects of the fundraising activities transacted via fundraising system 100. Specific aspects of the metric are analyzed and reported via reports module 112, then displayed at the web site for associated with a given retail sponsor. Accounts module 112 may also compile and publish a personalized fundraising campaign report reflecting cumulative fundraising payments associated with a given fundraiser's fundraising campaign, which may also be displayed within the web page showing impact of a given retailer's sponsorship. It is contemplated that such a web page or web site may be hosted either at the page is hosted at either fundraising platform server 101 or retailer server 103. Information displayed may be periodically updated as the cumulative fundraising transactions, including payments, associated with the retailer progresses over time.

Although preferred embodiments of the invention have been described herein, it will be understood by those skilled in the art that variations and combinations thereof may be made thereto without departing from the scope of the appended claims. For instance, it is contemplated that the methods performed and described herein may be performed in different orders or sequences than the illustrative embodiments presented herein.

What is claimed is:

1. A computer-implemented method, executed in a processor of a fundraising platform server associated with a fundraising service, of funding a fundraising campaign in relation to an offer for purchase provided by a retailer, the fundraising campaign, the fundraising service and the retailer having respective account balances, the fundraising campaign and the offer being accessible to a fund supporter computing device, the method comprising:
matching, at the fundraising platform server, a plurality of retailer offers against the fundraising campaign, the fundraising campaign specifying a plurality of campaign criteria;
generating, based on the matching, a plurality of offers for purchase from among the plurality of retailer offers;
selecting, via a fundraiser computing device, at least one offer for purchase from among the generated plurality of offers for purchase, the at least one offer comprising a monetary value;
publishing, via the fundraiser computing device, a fundraising campaign promoting the at least one offer;
selecting and purchasing, via a supporter computing device, the at least one offer promoted by the fundraising campaign;
generating a voucher at the fundraising platform server, the voucher specifying the monetary value of the purchased at least one offer;
redeeming the voucher via a purchase transaction with the retailer, the purchase transaction comprising at least a portion of the monetary value; and
allocating, from the at least a portion of the monetary value, a first payment to the fundraising campaign account balance and a second payment to the fundraising service account balance.

2. The method of claim 1 wherein the fundraising campaign and the retailer offer for purchase are provided via a website hosted by the fundraising platform server.

3. The method of claim 1 further comprising hosting the account balances of the fundraising service, the fundraising campaign and the retailer at the fundraising platform server.

4. The method of claim 1 wherein the plurality of campaign criteria specified by the fundraising campaign includes at least one geographical factor and at least one demographical factor.

5. The method of claim 1 further comprising compiling a fundraising report reflecting cumulative fundraising payments associated with the retailer.

6. The method of claim 5 further comprising publishing, at a website associated with the retailer, the cumulative fundraising payments of the retailer.

7. The method of claim 5 further comprising publishing, at a website hosted by the fundraising platform server, the cumulative fundraising payments of the retailer.

8. The method of claim 7 further comprising updating the cumulative fundraising payments of the retailer at a web-enabled display screen showing sponsorship impact.

9. The method of claim 1 further comprising compiling a personalized fundraising campaign report reflecting cumulative fundraising payments associated with the fundraising campaign in a display of fundraiser impact.

10. The method of claim 9 further comprising publishing the personalized fundraising campaign report.

11. A fundraising system for funding a fundraising campaign in relation to an offer for purchase provided by a retailer, the fundraising campaign and the offer being accessible to a fund supporter computing device, the system comprising:
a matching module at a fundraising platform server associated with a fundraising service, the matching module for matching a plurality of retailer offers against the fundraising campaign, the fundraising campaign specifying a plurality of campaign criteria, the matching module generating a plurality of offers for purchase from among the plurality of retailer offers and further generating a voucher, the voucher specifying the monetary value of a purchased at least one offer selected from among the plurality of retail offers;
a fundraiser computing device for selecting the at least one offer for purchase from among the plurality of retail offers, the at least one offer comprising a monetary value, the fundraiser computing device further for publishing the fundraising campaign promoting the at least one offer;
a supporter computing device for purchasing the at least one offer promoted by the fundraising campaign; and
an accounts module for tracking redemption of the voucher via a purchase transaction with the retailer, the purchase transaction comprising at least a portion of the specified monetary value of the voucher, the accounts module further for allocating, from the at least a portion of the monetary value, a first payment to a fundraising campaign account balance of the fundraising campaign and a second payment to a fundraising service account balance of the fundraising service.

12. The system of claim 11 wherein the fundraising campaign and the retailer offers for purchase are provided via a website hosted by the fundraising platform server.

13. The system of claim 11 wherein the account module comprising the account balances of the fundraising service and the fundraising campaign are hosted at the fundraising platform server.

14. The system of claim 11 wherein the plurality of campaign criteria specified by the fundraising campaign includes at least one geographical factor and at least one demographical factor.

15. The system of claim 11 further comprising a reports module for compiling a fundraising report reflecting cumulative fundraising payments associated with the retailer.

16. The system of claim 15 wherein the reports module publishes, to a website associated with the retailer, the fundraising report reflecting cumulative fundraising payments associated with the retailer.

17. The system of claim 16 wherein the reports module publishes, to at a website hosted by the fundraising platform server, the cumulative fundraising payments of the retailer.

18. The system of claim 15 wherein the reports module periodically updates the cumulative fundraising payments of the retailer at a web-enabled display screen showing sponsorship impact.

19. The system of claim 15 wherein the reports module compiles a personalized fundraising campaign report reflecting cumulative fundraising payments associated with the fundraising campaign in a display of fundraiser impact.

20. The system of claim 19 wherein the reports module publishes the personalized fundraising campaign report.
